(19) United States
(12) Patent Application Publication
(10) Pub. No.: US 2009/0032272 A1
(43) Pub. Date: Feb. 5, 2009

(54) Fluid Vessel and Method for Charging a Fluid Vessel

(76) Inventor: William James Duncan, Victoria (AU)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/223,293

(22) PCT Filed: Jan. 29, 2007
(86) PCT No.: PCT/AU2007/000069

§ 371 Date: Jul. 28, 2008

(30) Foreign Application Priority Data
Jan. 30, 2006 (AU) 2006900394

(51) Int. Cl. A62C 13/66; B05B 9/00; F17C 5/00; B01F 5/02

(52) U.S. Cl. 169/85; 141/3; 141/9; 220/585; 222/94; 222/399; 222/23

(57) ABSTRACT

In one arrangement there is provided a method of charging a fluid vessel (10). The vessel (10) comprises a rigid outer container, an expandable bladder (8) within the outer container in fluid communication with a release valve (9) of the fluid vessel (10). A cavity separates the rigid outer container and the bladder and the method comprises the steps of providing a first fluid (5a) to the cavity, for providing external pressure to the expandable bladder (8), and subsequently providing a second fluid (5) to the bladder (8) prior to use of the fluid vessel (10).

### FIELD OF INVENTION

The present invention relates generally to fluid vessels or containers used for discharging fluid contents therefrom. In particular, the present invention relates to a method of charging a fluid vessel and a fluid vessel adapted for charging.

In one form, the invention relates to a vessel for containing a fire retardant and it will be convenient to hereinafter describe the invention in relation to that particular form with the use of water as a fire retardant in a water stored pressure fire extinguisher, however it should be appreciated that the present invention is not limited to that application, only.

### BACKGROUND ART

Throughout this specification the use of the word “inventor” in singular form may be taken as reference to one (singular) or all (plural) inventors of the present invention. The inventor has identified the following related art.

With reference to FIG. 1, water stored pressure fire extinguishers 10 are typically comprised of a stainless steel or organically lined carbon steel cylinder 1, a valve 2 that enables the contents to be expelled when a trigger 3 is depressed, and a siphon tube 4 that connects the valve 2 to the bottom of the cylinder 1.

The cylinder 1 may be filled with retardant 5 such as water, which may include additives if required, to a predetermined volume, and the cylinder is pressurised by means of a pressurising valve (usually an automotive Schrader valve) with typically a fluid 5a such as air or nitrogen which is connected to the siphon tube, to a pressure (P₁) that will expel the fluid contents at the desired rate. Effectively, the ullage space shown in FIG. 1 is pressurized with a propellant gas 5a for use upon the retardant.

When the trigger 3 is depressed, the water 5 is forced up the siphon tube 4 and through the hose 6, where the stream is concentrated by the nozzle 7 to deliver the fluid with required fire fighting characteristics.

A cross section of a typical valve 2 associated with the fire extinguisher 10 shown in FIG. 1 is shown in FIG. 2. The charging pressure P₁ is designed to retain sufficient energy to maintain an efficient fire fighting stream for the duration of the discharge of the contents. The residual pressure P₂ remaining when all of the contents have been discharged is expelled through the nozzle 7 at the end of the discharge.

Water extinguishers are usually assembled and pressurised, then undergo a sophisticated leak detection process before being shipped empty to save the cost of shipping water or other heavy fluids over vast distances. Typically mass spectrometer detection of a helium trace in the charging gas is used for the leak detection. Before the extinguisher is delivered to its final destination, it is dismantled, filled with water, reassembled and pressurised. There may typically be very few filling facilities that have leak detection facilities better than the likes of water baths, and most extinguishers may be charged in the field with no leak detection facilities at all.

The disadvantages with this conventional system are that the extinguisher has to be dismantled to charge it on site, thus negating the sophisticated leak detection techniques used during manufacture, and furthermore it may lose pressure before the next scheduled inspection. It may not always be practical to fill and pressurise extinguishers at remote sites, as this may require a compressed gas cylinder to pressurise the extinguisher, which introduces OH&S risks.

In areas of high salinity or where water is chlorinated for health reasons, commercial grades of stainless steel used as the container 1 for the fire extinguisher 10 may be prone to corrosion by the retardant contents 5, and when installed in direct sun where there are large temperature cycles, the bonding between an organic lining and the cylinder 1 may fail, and allow corrosion to occur. The pressure envelope of many extinguishers may fail at a fraction of the expected service life of the extinguisher as a result of these problems.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present invention is to alleviate at least one disadvantage associated with the prior art.

In one aspect the present invention provides a method of charging a fluid vessel, said vessel comprising a rigid outer container, an expandable bladder within the outer container in fluid communication with a release valve of the fluid vessel and, a cavity separating the rigid outer container and the bladder, said method comprising the steps of:
providing a first fluid to the cavity for providing external pressure to the expandable bladder;
subsequently providing a second fluid to the bladder prior to use of the fluid vessel.

In another aspect, the present invention provides a fluid vessel comprising a rigid outer container, an expandable bladder within the outer container in fluid communication with a release valve of the fluid vessel and, a cavity separating the rigid outer container and the bladder, wherein the fluid vessel further comprises:
first fluid charging means adapted to charge the cavity with a first fluid for providing a first predetermined external pressure to the expandable bladder;
second fluid charging means adapted to subsequently provide a second fluid to the bladder prior to use of the vessel.

Other aspects and preferred aspects are disclosed in the specification and/or defined in the appended claims, forming a part of the description of the invention.

In essence, the present invention stems from the realisation that by use of a bladder to separate a first (propellant) fluid from a second dischargeable fluid of a vessel allows the vessel to be charged in the field or at its location of use with dischargeable fluid for use with the vessel without affecting the first fluid that may be under pressure within the vessel. Furthermore, it is realised that providing this separation of fluids may prevent corrosion of the container by the dischargeable fluid when a first fluid that is compatible with the container is used and also substantially prevent any compromising of leak detection by virtue of using the first fluid to test for leakage.

According to a further aspect of the present invention there is provided a fluid vessel accessory, for use when charging the vessel, the accessory comprising: a body providing a storage space for holding material; an inlet for receiving a stream of fluid; and an outlet for discharging said stream of fluid once received through the inlet; wherein the inlet is arrange to direct the stream of fluid into the storage space such that stream of fluid draws the material held therein through the outlet.

According to another aspect of the present invention there is provided an indicator for a fluid vessel, wherein the indicator includes defined portions for indicating refill and recharge conditions.

Advantageously preferred embodiments of the accessory according to the present invention allow for the incorporation of additives into the fluid stream when charging or refilling the fluid vessel. In some embodiments the additives comprise fire retardant. In other embodiments the additives comprise weed killer concentrate.

In the context of the present invention, it is to be taken that the term “fluid” applies to any material that displays liquid-like or gas-like behaviour, physical and/or chemical properties.

Throughout the description herein it is to be taken that the term “compatible” in the context of fluids compatible with the rigid outer container means that the compatible fluid has no corrosive physical or chemical effect on the outer container. Furthermore, in a preferred embodiment, the present invention provides a method of charging a fire extinguisher and fire extinguisher apparatus suitable for use in accordance with the present invention. In the following description of that preferred embodiment, the dischargeable fluid may comprise retardant and, the term “retardant” is to be taken as a reference to fluids suitable for retarding the progress of a fire. As such retardants may comprise extinguishants as would be known by the person skilled in the art or other such fluids that may be suitable for combating fires.

The present invention has been found to result in a number of advantages, such as:
Minimised possibility of corrosion of the cylinder by its contents.
A vessel does not need to be dismantled to charge it.
Vessel may be shipped empty and filled on site using the likes of a garden hose or internal tap outlet without separate pressurising equipment.
Leak testing of the pressure envelope may be performed during manufacture only is not compromised during charging.
Vessels may be cheaper to manufacture than vessels with stainless steel or organically lined cylinders to provide protection.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limiting to the scope of the present invention, and in which:

FIG. 1 is a cross sectional side view of an example of a conventional vessel in the form of a water stored pressure fire extinguisher;

FIG. 2 is a cross sectional side view of a valve arrangement used in the conventional vessel shown in FIG. 1.

FIG. 3 is a cross sectional side view of a vessel in accordance with a preferred embodiment of the present invention;

FIG. 4 is a cross sectional side view of a valve arrangement used in the vessel shown in FIG. 3 in accordance with a preferred embodiment of the present invention.

FIG. 5 is a cross sectional side view of an accessory in accordance with a preferred embodiment of the present invention.

FIG. 6 is a schematic view of an indicator in accordance with a further preferred embodiment of the present invention.

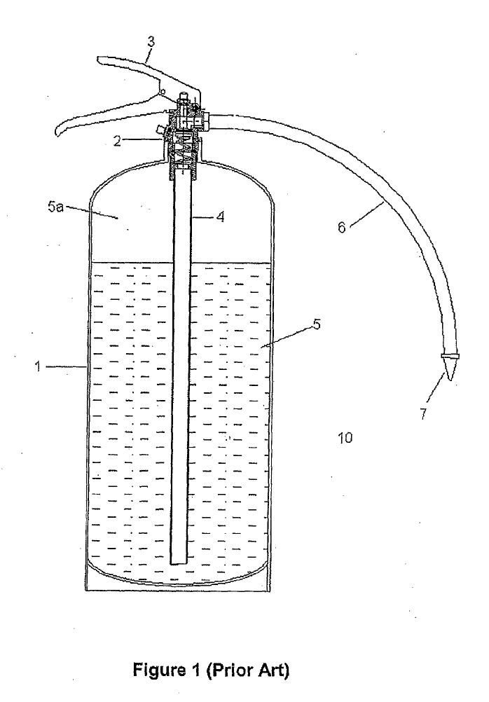

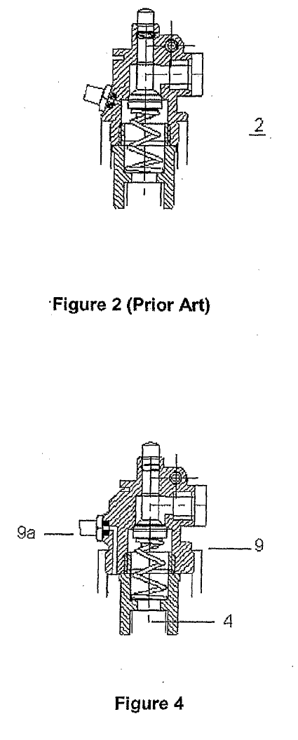

### DETAILED DESCRIPTION

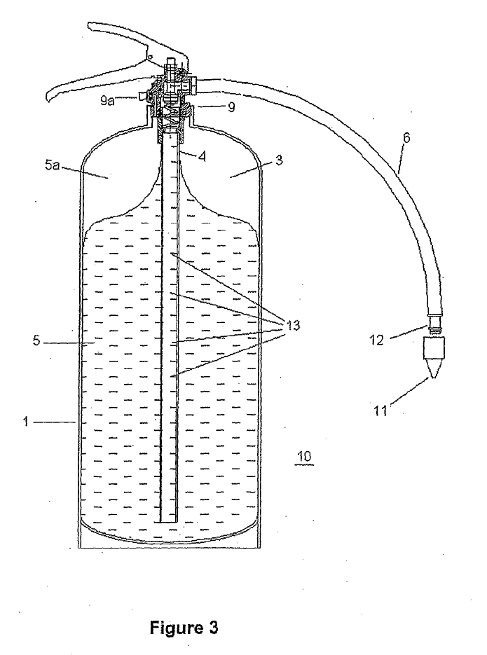

The design improvement of embodiments of the present invention encloses a second fluid 5, water as a fire retardant in a most preferred form, in a flexible bag or bladder 8 to separate it from the cylinder 1 as best shown in FIG. 3, thus substantially preventing risk of corrosion of the cylinder 1 by its contents.

In its preferred operation the vessel 10 may be used by activating the release valve 9 to discharge the second fluid 5 from the vessel 10; and repeating the step of subsequently providing a second fluid 5a to the bladder 8 after use of the vessel 10 to provide re-use of the vessel 10 in the field.

The charging valve 9a for the first fluid may be connected directly to the ullage space between the bag 8 and the cylinder 1, (ie the ullage space corresponding to the amount that the container lacks of being full) as shown best in FIG. 4, and not the siphon tube 4 as in conventional extinguishers 10. When the extinguisher 10 is charged with first fluid 5a through the charging valve 9a, the space between the cylinder 1 and the bag 8 is pressurised. Preferably, the step of providing a first fluid 5a to charge the cavity is performed on manufacture of the vessel 10 or, immediately upon assembly of the vessel 10.

When the vessel 10 is discharged, the contents are expelled from the bag 8, but the propellant charge 5a is retained between the bag 8 and the cylinder 1.

Upon formation of the vessel 10, an electronic leak detection method may be used to test the device before it is shipped into the field. One form of electronic detection use acoustic emissions as would be recognised by the person skilled in the art. In other forms of leak detection, materials are used for detection. Helium is the most common, although other gases that only occur naturally in minute quantities can be used. With reference to FIGS. 3 and 4, in the preferred embodiment of a fire extinguisher, during manufacture, the extinguisher 10 is pressurised with a helium dosed gas 5a to a pressure P₂, which enables mass spectrometer leak detection of the pressure envelope by testing both the cylinder 1 and the discharge passage.

When the extinguisher 10 is delivered to site, a detachable nozzle 11 may be removed, and a hose 6 may be connected to a water supply via a commercial snap on connector 12 as shown in FIG. 3. Alternatively, the fire retardant 5 used to charge the vessel 10 may comprise one or a combination of:
a gas;
a liquid;
a foam.

In one particular embodiment a retardant comprises conventional foam in which the bubbles are filled with CO₂, not air.

Preferably, the hose connector 12 comprises a snap on water hose connector; and
the second source of fluid comprises a water source, which may be in the form of a domestic household water supply.

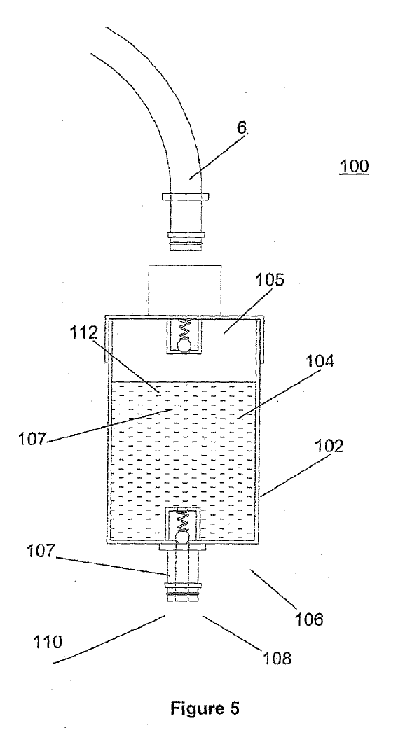

Referring to FIG. 5 there is shown a fluid vessel accessory 100 according to a preferred embodiment of the present invention. The accessory comprises a body 102 providing a storage space 104 for holding an additive 106. An inlet 108 is arranged to receiving a stream of fluid 110 and directing the stream of fluid into the storage space, after which an outlet 112 discharges the stream of fluid 110 with mixed additive 106 therein.

With the embodiments described the hose 6 is connected to the accessory 100 which provides an auxiliary charging vessel for the extinguisher 10. The charging vessel 100 has removable caps at both the inlet and outlet with male and female snap connectors 105 and non return valves 107. When filled with a additive such as foam concentrate and connected to the water supply, the additive is delivered to the extinguisher 10.

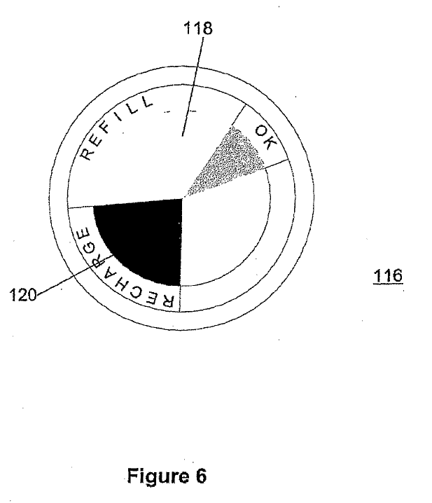

An indicator 116 for the fire extinguisher 10 is shown in FIG. 6. The indicator 116 includes defined portions 118 and 120 indicating refill and recharge conditions. This is particularly advantageous because it allows the user to determine whether the fire extinguisher 10 should be refilled or recharged. With the indication however it is advisable that the fire extinguisher be weighed to confirm the amount of retardant therein, and thus to ensure that the indicator correctly indicates the condition of the extinguisher. Inter alias, the pressure gauge indicator 116 differs from that fitted to conventional extinguishers by having a sector marked “Refill” in addition to “OK” and “Recharge” regions.

Whilst an auxiliary charging attachment and an indicator for retardant additives have been described, auxiliary charging attachments and indicators for weed killing and other applications, such as mining applications, are also envisaged.

The fluid vessel 10 may comprise one of a fire extinguisher and, more generally, an aerosol container for use with consumer products that may be utilised under pressure and such products may utilise water as either the working (dischargeable) fluid or in combination with an additive for a dischargeable fluid 5. The present invention may easily be applied, without limitation, to vessels such as a garden sprayer, fire fighting backpack spray, cleaning solution applicator, animal drenching gun, or any other device required to expel, for example, a water based solution. In the case of water based dischargeable fluids, an additive may be added via a dispenser included in the filling connection. It is also envisaged that many of these discharging (dispensing) vessels may further comprise an air pump to provide the required discharge pressure. The air pump is incorporated in current designs of these products, but would not be required with this invention. In this respect, the second (dischargeable) fluid 5 generally may comprise a gas, a liquid, foam or a combination thereof.

When providing a first fluid 5a to the cavity the vessel 10 is pressurised with the first fluid 5a to a first predetermined pressure. This first predetermined pressure may correspond with residual pressure P₂ noted above for conventional systems, which is a pressure sufficient to expel the bladder 8 of its contents. When subsequently providing a second fluid 5 to the bladder 8 the vessel is pressurised to a second predetermined pressure that generally may correspond to charging pressure P₁ noted above for conventional systems that is designed to retain sufficient energy to maintain an efficient discharge stream for the duration of the discharge. In the preferred embodiment, the efficient discharge stream would comprise an efficient fire fighting stream of retardant or extinguishant. In the preferred example of a water stored pressure extinguisher, if the water supply pressure is greater than P₁, the extinguisher 10 may be filled until the pressure gage reads “full”, which will result in the correct volume of water in the extinguisher 10, and the system pressurised to P₁. If there is insufficient water pressure to reach P₁, the supply pressure can be supplemented with a simple hand or foot pump, which can also be used to introduce additives, such as foam or anti-freeze.

The present invention may also have applications in larger fire systems. In this respect, pressurised fire extinguisher cylinders are often used to protect vehicles as part of a fire protection system. In the event of a rollover, the cylinders will not discharge the full contents when the vehicle is upside down, even if a flexible siphon tube is fitted. These systems also experience the same corrosion and leakage problems as portable extinguishers.

In a preferred embodiment, the vessel comprises a siphon tube 4 as shown in FIG. 3 wherein the elongated siphon tube 4 comprises a plurality of apertures 13 along the length of the tube 4 and providing fluid communication between the bladder 8 and the connection means (comprising valve 9, hose 6 and nozzle 11). The elongated siphon tube 4 projecting into the bladder 8, connected at one end thereof to the release valve 9 and terminating at the other end thereof proximate an end wall of the outer container 1 also forms part of the connection means. By addition of holes 13 along the length of the siphon tube 4 of the improved extinguisher design, all of the contents of the cylinder 1 may be discharged at any angle. Holes 13 adjacent to the air space in the cylinder may be blocked by the bladder 8 being forced against them by fluid pressure.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure. wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1. A method of charging a fluid vessel, said vessel comprising a rigid outer container, an expandable bladder within the outer container in fluid communication with a release valve of the fluid vessel and, a cavity separating the rigid outer container and the bladder, said method comprising the steps of:
providing a first fluid to the cavity for providing external pressure to the expandable bladder;
subsequently providing a second fluid to the bladder prior to use of the fluid vessel.

2. A method as claimed in claim 1 wherein the step of providing a first fluid to the cavity comprises pressurising the vessel with the first fluid to a first predetermined pressure.

3. A method as claimed in claim 1 wherein the step of subsequently providing a second fluid to the bladder comprises pressurising the vessel to a second predetermined pressure.

4. A method as claimed in claim 1 wherein the step of subsequently providing a second fluid to the bladder comprises:
connecting the bladder to a fluid source available at the locality in which the vessel is to be used.

5. A method as claimed in claim 1 wherein the step of providing a first fluid to the cavity is performed on manufacture of the vessel.

6. A method as claimed in claim 1 further comprising the step of:
performing leak detection to determine leakage of the first fluid from the vessel.

7. A method as claimed in claim 6 wherein the step of leak detection is performed on manufacture of the vessel.

8. A method as claimed in claim 2 wherein the first predetermined pressure is sufficient to substantially expel the second fluid from the vessel upon activation of the release valve.

9. A method as claimed in claim 1 further comprising the steps of:
using the vessel by activating the release valve to discharge the second fluid from the vessel;
repeating the step of subsequently providing a second fluid to the bladder after use of the vessel.

10. A method as claimed in claim 1 wherein the first fluid comprises a gas.

11. A method as claimed in claim 10 wherein the gas comprises a propellant.

12. A method as claimed in claim 10 wherein the gas comprises a helium dosed gas for enabling mass spectrometer leak detection to determine leakage of fluid from the vessel.

13. A method as claimed in claim 1 wherein the first fluid is compatible with at least the rigid container.

14. A method as claimed in claim 1 wherein the second fluid comprises one or a combination of:
a gas;
a liquid;
a foam.

15. A method as claimed in claim 1 wherein the second fluid comprises a fire retardant.

16. A method as claimed in claim 1 wherein the step of subsequently providing a second fluid to the bladder comprises:
connecting the bladder to a water supply via a hose connection to the release valve.

17. A method as claimed in claim 1 wherein the fluid vessel comprises one of:
a fire extinguisher;
an aerosol container;
a garden sprayer;
a backpack sprayer;
a cleaning solution applicator;
an animal drenching gun device;
a device adapted for expelling a water based solution.

18. A fluid vessel comprising a rigid outer container, an expandable bladder within the outer container in fluid communication with a release valve of the fluid vessel and, a cavity separating the rigid outer container and the bladder, wherein the fluid vessel further comprises:
first fluid charging means adapted to charge the cavity with a first fluid for providing a first predetermined external pressure to the expandable bladder;
second fluid charging means adapted to subsequently provide a second fluid to the bladder prior to use of the vessel.

19. A vessel as claimed in claim 18 wherein the second fluid charging means is adapted to pressurise the vessel with the second fluid to a second predetermined pressure.

20. A vessel as claimed in claim 18 wherein the second fluid charging means comprises connection means for connecting the bladder to a source of second fluid available at the locality in which the vessel is to be used.

21. A vessel as claimed in claim 18 wherein the first predetermined pressure is sufficient to substantially expel the second fluid from the vessel upon activation of the release valve.

22. A vessel as claimed in claim 18 wherein the vessel is adapted for use by activating the release valve to discharge the second fluid from the vessel.

23. A vessel as claimed in claim 18 wherein the first fluid comprises a gas.

24. A vessel as claimed in claim 23 wherein the gas comprises a propellant.

25. A vessel as claimed in claim 23 wherein the gas comprises a helium dosed gas for enabling mass spectrometer leak detection to determine leakage of fluid from the vessel.

26. A vessel as claimed in claim 18 wherein the first fluid is compatible with at least the rigid container.

27. A vessel as claimed in claim 18 wherein the second fluid comprises one or a combination of:
a gas;
a liquid;
a foam.

28. A vessel as claimed in claim 18 wherein the second fluid comprises a fire retardant.

29. A vessel as claimed in claim 18 wherein the fluid vessel comprises one of:
a fire extinguisher;
an aerosol container;
a garden sprayer;
a backpack sprayer;
a cleaning solution applicator;
an animal drenching gun device;
a device adapted for expelling a water based solution.

30. A vessel as claimed in claim 20 wherein the connection means comprises:
a hose adapted for connection to the release valve at one end thereof and comprising a hose connector for detachable connection to the source of second fluid at a second end thereof.

31. A vessel as claimed in claim 30 wherein the connection means further comprises a nozzle adapted for connection to the second end of the hose for providing a concentrated stream of second fluid when the vessel is in use.

32. A vessel as claimed in claim 30 wherein:
the hose connector comprises a snap on water hose connector; and
the second source of fluid comprises a water source.

33. A vessel as claimed in claim 30 wherein the connection means further comprises an elongated siphon tube projecting into the bladder and connected at one end thereof to the release valve and terminating at the other end thereof proximate an end wall of the outer container.

34. A vessel as claimed in claim 33 wherein the elongated siphon tube comprises a plurality of apertures along the length of the tube and providing fluid communication between the bladder and the connection means.

35. A method of charging a fluid vessel, comprising:
discharging fluid, stored in a expandable bladder within the fluid vessel, the fluid being discharged through a release value of the fluid vessel; and
repressurizing the expandable bladder after discharging the fluid.

36. A method as claimed in claim 35 wherein repressurizing the expandable bladder includes refilling the expandable bladder with fluid through a discharge tube extending outwardly away from the fluid vessel, the fluid having been discharged through the discharge tube.

37. A method as claimed in claim 36 wherein repressurizing the expandable bladder includes recharging a cavity within the fluid vessel to provide an increased external pressure to the expandable bladder.

38. A fluid vessel accessory, for use when charging the vessel, the accessory comprising: a body providing a storage space for holding material; an inlet for receiving a stream of fluid; and an outlet for discharging said stream of fluid once received through the inlet; wherein the inlet is arrange to direct the stream of fluid into the storage space such that stream of fluid draws the material held therein through the outlet.

39. An indicator for a fluid vessel, wherein the indicator includes defined portions for indicating refill and recharge conditions.

40. (canceled)

41. (canceled)
